(19) United States
(12) Patent Application Publication
(10) Pub. No.: US 2025/0265116 A1
(43) Pub. Date: Aug. 21, 2025

(54) RESOURCE SCHEDULING METHOD, NODE, DEVICE, MEDIUM, AND PROGRAM PRODUCT

(71) Applicant: Tencent Technology (Shenzhen) Company Limited, Shenzhen (CN)

(72) Inventors: Liangyu Zhou, Shenzhen (CN); Kaiyue Chen, Shenzhen (CN)

(73) Assignee: Tencent Technology (Shenzhen) Company Limited, Shenzhen (CN)

(21) Appl. No.: 19/198,313

(22) Filed: May 5, 2025

Related U.S. Application Data
(63) Continuation of application No. PCT/CN2024/079856, filed on Mar. 4, 2024.

(30) Foreign Application Priority Data
Apr. 28, 2023 (CN) 202310488044.2

(51) Int. Cl. G06F 9/48; G06F 9/50

(52) U.S. Cl. CPC G06F 9/4881; G06F 9/505

(57) ABSTRACT

A resource scheduling method, applied to a virtual node, wherein a configurable resource of the virtual node is determined based on an idle resource of at least one computing node, the resource scheduling method includes receiving, from a scheduling node, a first computing task including resource information indicating a computing resource quantity for executing the first computing task; performing, based on the configurable resource indicating that there is a target computing node, from among the at least one computing node, that satisfies the resource information, format conversion on the resource information based on a field format of the idle resource to obtain a second computing task, wherein the second computing task may include information about the target computing node for assigning the second computing task for execution; and transmitting the second computing task to the scheduling node.

### CROSS-REFERENCE TO RELATED APPLICATIONS

This application is a continuation application of International Application No. PCT/CN2024/079856 filed on Mar. 4, 2024, which claims priority to Chinese Patent Application No. 202310488044.2 filed with the China National Intellectual Property Administration on Apr. 28, 2023, the disclosures of each being incorporated by reference herein in their entireties.

### FIELD

The disclosure relates to the field of computer technologies, and to a resource scheduling method, a node, a device, a medium, and a program product.

### BACKGROUND

A container cluster management system (such as Kubernetes, K8s) is a container-based cluster management platform. A plurality of computing nodes may be deployed in a cluster managed by K8s. Because there are always some idle resources caused by resource fragmentation and low load in the computing nodes, how to reuse these idle resources becomes a problem to be urgently resolved.

Because a control node Operator may be used to start a computing task for most services, when the idle resources are reused, native code of the control node may be modified to convert a data format of native resources in a computing task for a service into a data format of the idle resources. A strong intrusion is caused to code.

### SUMMARY

According to an aspect of the disclosure, a resource scheduling method, applied to a virtual node, wherein a configurable resource of the virtual node is determined based on an idle resource of at least one computing node, the resource scheduling method includes receiving, from a scheduling node, a first computing task including resource information indicating a computing resource quantity for executing the first computing task; performing, based on the configurable resource indicating that there is a target computing node, from among the at least one computing node, that satisfies the resource information, format conversion on the resource information based on a field format of the idle resource to obtain a second computing task, wherein the second computing task includes information about the target computing node for assigning the second computing task for execution; and transmitting the second computing task to the scheduling node.

According to an aspect of the disclosure, a virtual node, wherein a configurable resource of the virtual node is determined by an idle resource of at least one computing node, the virtual node includes at least one memory configured to store computer program code; and at least one processor configured to read the program code and operate as instructed by the program code, the program code includes receiving code configured to cause at least one of the at least one processor to receive, from a scheduling node, a first computing task including resource information indicating a computing resource quantity for executing the first computing task; format conversion code configured to cause at least one of the at least one processor to perform, based on the configurable resource indicating that there is a target computing node, from among the at least one computing node, that satisfies the resource information, format conversion on the resource information based on a field format of the idle resource to obtain a second computing task, wherein the second computing task includes information about the target computing node for assigning the second computing task for execution; and transmitting code configured to cause at least one of the at least one processor to transmit the second computing task to the scheduling node.

According to an aspect of the disclosure, a non-transitory computer-readable storage medium, storing computer code which, when executed by at least one processor, causes the at least one processor to at least receive a first computing task from a scheduling node, the first computing task including resource information, wherein the resource information indicates a computing resource quantity for executing the first computing task; perform, based on a configurable resource of a virtual node indicating that there is a target computing node, from among at least one computing node, that satisfies the resource information, format conversion on the resource information based on a field format of an idle resource of the at least one computing node to obtain a second computing task, wherein the second computing task includes information about the target computing node for assigning the second computing task for execution; and transmit the second computing task to the scheduling node.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of a structure of a resource scheduling system according to some embodiments.

FIG. 2 is a schematic flowchart of a resource scheduling method according to some embodiments.

FIG. 3 is a schematic diagram of a structure of a virtual node according to some embodiments.

FIG. 4 is a schematic diagram of distribution of a total resource of a computing node according to some embodiments.

FIG. 5 is a schematic diagram of an effect of a deployment scenario of a virtual node according to some embodiments.

FIG. 6 is a schematic flowchart of another resource scheduling method according to some embodiments.

FIG. 7 is a schematic flowchart of still another resource scheduling method according to some embodiments.

FIG. 8 is a schematic diagram of a structure of a virtual node according to some embodiments.

FIG. 9 is a schematic diagram of a structure of a scheduling node according to some embodiments.

FIG. 10 is a schematic diagram of a structure of a computer device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

The following describes some concepts in some embodiments.

### 1. Application Programming Interface Server (API Server)

The API server provides a resource representational state transfer (HTTP Rest) interface for adding, deleting, modifying, querying, and obtaining various resource objects in Kubernetes, and is a data bus and a data center of an entire system. Functions of the API server may include: (1) A Rest application programming interface (API) for cluster management (including authentication and authorization, data verification, and cluster state change) is provided. (2) A hub for data exchange and communication between other modules is provided (the other modules query or modify data through the API server). (3) The API server is an entry for resource quota control. (4) The API server has a complete cluster security mechanism.

### 2. Application Program Controller

The application program controller (Operator) is a control node in some embodiments, and is configured to extend a Kubernetes API, and create, configure, and manage a complex stateful application, for example, a system such as a database or a cache. The Operator is constructed based on a resource of Kubernetes and a controller, and also includes field knowledge relating to an application program.

### 3. Pod

The Pod is equivalent to a logical host, and each Pod has an IP address thereof. A container in the Pod shares the same IP and port space, and by default, a file system of each container is completely isolated from that of another container. A Pod may also be understood as a container group. The Pod is also equivalent to a logical host. One Pod includes one group of containers, and one Pod does not span a plurality of operating nodes. An objective of the Pod is to provide process isolation for a service. A container to which the service is correspondingly mapped can be run in an independent Pod. A basic container (for example, a Pause container) is run in each Pod, and other containers are service containers. These service containers share a network stack and a volume of the Pause container. The container in one Pod can directly communicate with a Pod container on another host. To establish an association relationship between the service and the Pod, Kubernetes attach a label to each Pod, the service also defines a label selector, and a Pod of a corresponding label is found through the label selector of the service.

### 4. Computing Node

The computing node is a container running environment, which is a docker environment (an rkt environment similar to the docker environment is also used). A K8s agent (Kubelet) is run to communicate with a master. The computing node may also run some additional functions, such as log recording and service discovery. The computing node is a truly operating node in a K8s cluster.

A control node may be used to start a computing task for most services. When an idle resource is reused, because a field format of resource information in the computing task is different from a field format used by the idle resource in the computing node, if the idle resource in the computing node is to be used, the field format of the resource information in the computing task may be modified into the field format used by the idle resource. When the field format is modified by using the control node, native code of the control node may be modified. A strong intrusion is caused to code.

Some embodiments provide a resource scheduling method, a node, a device, a medium, and a program product. A scheduling node cooperates with a virtual node, to reuse an idle resource of a computing node in a cluster. The virtual node obtains an idle resource of at least one computing node, and performs conversion processing on a field format of the idle resource based on a field format of a configurable resource, to obtain the configurable resource of the virtual node. The configurable resource is reported to the scheduling node, so that the virtual node is incorporated into the scheduling node when the scheduling node may schedule the computing task subsequently. When the computing task (for example, a first computing task is to be scheduled, it is determined that the computing task is to be scheduled to the virtual node by using the configurable resource. The virtual node determines, based on resource information that is included in the computing task and that is configured for representing a computing resource quantity for executing the computing task and the configurable resource, whether there is a target computing node satisfying the resource information in the at least one computing node. If there is the target computing node satisfying the resource information, format conversion is performed on the resource information in the computing task based on the field format of the idle resource, and a converted computing task is transmitted to the scheduling node, so that the scheduling node can execute a second computing task based on the target computing node.

Solutions provided in some embodiments may be applied to a multi-cluster platform in which a plurality of clusters are deployed online and offline in a mixed manner, or may be applied to a single-cluster platform in which a plurality of clusters are deployed online or offline in an independent manner.

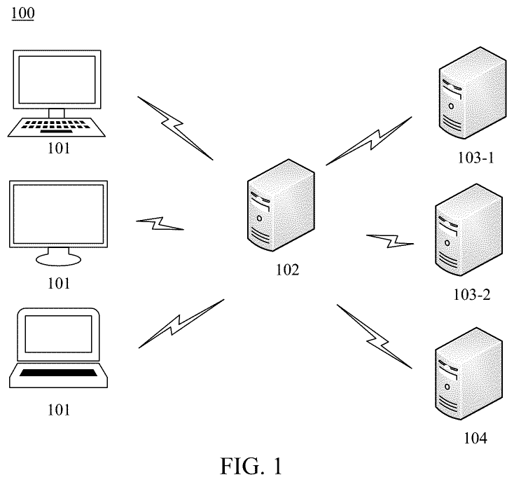

FIG. 1 is a schematic diagram of an application scenario of a resource scheduling system according to some embodiments. In the scenario, a terminal device 101, a scheduling node 102, a computing node 103, and a virtual node 104 are included. A quantity of computing nodes 103 is large, referring to a computing node 103-1 to a computing node 103-n shown in FIG. 1. The virtual node 104 and the computing node 103 may be deployed in a same cluster, or may be deployed in different clusters. FIG. 1 shows that the virtual node 104 and the computing node 103 are deployed in a same cluster.

A cluster in which the virtual node 104 is deployed is determined based on a cluster in which a service that the virtual node 104 may perform is located and an obtained cluster in which the computing node 103 is located.

In a single-cluster scenario, the virtual node 104 and the computing node 103 are deployed in a same cluster. In a multi-cluster scenario in which a plurality of clusters are deployed online and offline in a mixed manner, based on a current calculation amount of an online service and a calculation amount of an offline service, the calculation amount of the offline service may be greater than the calculation amount of the online service. The virtual node 104 is deployed in an offline cluster, to count an idle resource of an online cluster that can be accessed by the virtual node 104, and enable the offline service to use the idle resource of the online cluster.

The terminal device 101 may be a smartphone, a tablet computer, a laptop computer, a desktop computer, a smart speaker, a smart watch, or the like, but this is not limited thereto. The terminal device 101 may open a page of the multi-cluster platform or the single-cluster platform corresponding to the scheduling node 102, for example, open a corresponding page through a browser or a client. A user may submit a computing task thereof on the page. The computing task may be an online computing task or an offline computing task.

The scheduling node 102 may be a management end of the multi-cluster platform or the single-cluster platform, and the computing node 103 is a task execution end of the multi-cluster platform or the single-cluster platform. The scheduling node 102, the computing node 103, and the virtual node 104 may be implemented through a server. The server may be an independent physical server, or may be a server cluster or a distributed system including a plurality of physical servers, or may be a cloud server that provides a cloud service, a cloud database, cloud computing, a cloud function, cloud storage, a network service, cloud communication, a middleware service, a domain name service, a security service, a content delivery network (CDN), and a cloud computing service such as big data and an artificial intelligence platform. A terminal may be a smartphone, a tablet computer, a laptop computer, a desktop computer, a smart speaker, a smart watch, or the like, but this is not limited thereto. The terminal and the server may be connected directly or indirectly in a wired or wireless communication manner. The disclosure is not limited thereto.

For example, the virtual node 104 counts an idle resource of at least one computing node 103, and performs format conversion on the idle resource, to obtain a configurable resource. The configurable resource is reported to the scheduling node 102. When the user submits the computing task (for example, a Pod) to the terminal device 101, the scheduling node 102 may determine the corresponding computing node 103 for the computing task according to a load balancing policy. If there is no corresponding computing node 103 that can execute the computing task, and when the configurable resource in the virtual node 104 satisfies a computing resource quantity for executing the computing task, the scheduling node 102 schedules the computing task to the virtual node 104. When determining, based on resource information and the configurable resource in the computing task, that there is a target computing node satisfying the resource information in the at least one computing node 103, the virtual node 104 performs format conversion on the resource information in the computing task based on a field format of the idle resource, and transmits a converted computing task to the scheduling node 102. The scheduling node 102 executes a second computing task based on the target computing node.

In an application scenario, the cluster platform in some embodiments may be a cloud platform. The cloud platform is an architecture platform constructed based on a cloud technology. The cloud technology is a hosting technology that unifies a series of resources such as hardware, software, and a network in a wide area network or a local area network, to implement data computing, storage, processing, and sharing. The cloud technology is a term for a network technology, an information technology, an integration technology, a management platform technology, and an application technology that are applied based on a cloud computing business model. The cloud technology can form resource pools and be used on demand. This is flexible and convenient. A cloud computing technology is becoming an important support. A background service of a technical network system may use a large quantity of computing and storage resources, such as a video website, an image website, and more portal websites. With the development and application of the Internet industry, in the future, each item may have an identification flag and may be transmitted to the background system for logic processing. Data of different levels is processed separately. Various types of industry data use powerful system support, and this may be implemented through cloud computing.

Some embodiments are described below with reference to FIG. 1.

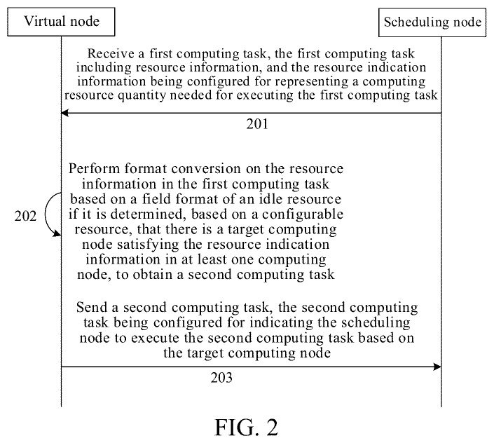

As shown in FIG. 2, some embodiments provide a resource scheduling method. The method may be applied to the virtual node 104 shown in FIG. 1. A configurable resource of the virtual node is determined based on an idle resource of at least one computing node. The method includes the following operations.

201: Receive a first computing task from a scheduling node, the first computing task including resource information, and the resource information being configured for representing a computing resource quantity for executing the first computing task.

In some embodiments, the idle resource of the computing node includes an unallocated computing resource and an allocated and unused computing resource in the computing node. A computing task submitted through a Kubernetes cluster platform is referred to as a Pod. The unallocated computing resource is a resource without a Pod declaration. The allocated and unused computing resource is an actually unused resource with a Pod declaration.

In some embodiments, the resource information includes, but is not limited to, a central processing unit (CPU) demand amount, a memory (Mem) demand amount, and the like.

In some embodiments, the computing resource quantity for executing the first computing task falls within a range of the configurable resource of the virtual node. The configurable resource of the virtual node is a total quantity of idle resources of the at least one computing node. The virtual node obtains the idle resource of each of the at least one computing node, and performs summation on the idle resource of each computing node, to obtain the configurable resource of the virtual node.

The first computing task may be an online computing task or an offline computing task, and a corresponding virtual node is configured to receive the online computing task or the offline computing task.

In some embodiments, the online computing task and the offline computing task are both submitted through the cluster platform. The online computing task and the offline computing task may be distinguished from each other. Options of the online computing task and the offline computing task may be provided to a user, so that a corresponding type label is provided to a computing task submitted by the user based on a selection of the user. When the user selects the offline computing task, a type label corresponding to the offline computing task is added to the computing task submitted by the user. When the user selects the online computing task, a type label corresponding to the online computing task is added to the computing task submitted by the user.

In some embodiments, because task attributes may include only the online computing task and the offline computing task, only the offline computing task may be marked, and the task is the online computing task when no type label is added.

When the cluster platform is the Kubernetes cluster platform, a label function of the Kubernetes cluster platform may be used. A computing task submitted through the Kubernetes cluster platform is referred to as a Pod. Each Pod may be added with a user-defined annotation, to present different attributes. An annotation may be added to the offline computing task, and then whether the task is the offline computing task may be distinguished based on the annotation.

202: Perform format conversion on the resource information in the first computing task based on a field format of the idle resource if it is determined, based on the configurable resource, that there is a target computing node satisfying the resource information in the at least one computing node, to obtain a second computing task.

In some embodiments, the target computing node may be a computing node that executes the first computing task, for example, the target computing node for scheduling the first computing task. The target computing node herein is unique. The target computing node is an ultimate execution node for the first computing task that is determined by the virtual node.

In an actual application, when the target computing node is the ultimate execution node for the first computing task, the virtual node may add a related identifier of the target computing node to the second computing task, to indicate the scheduling node to directly perform scheduling based on the identifier of the target computing node carried in the second computing task when the scheduling node schedules the second computing task.

In some embodiments, the target computing node may be a computing node satisfying execution of the first computing task. The target computing node herein may not be unique. Any computing node satisfying the execution of the first computing task may be the target computing node. The target computing node is a computing node that is determined by the virtual node in the at least one computing node and that may execute the first computing task, and is not the ultimate execution node for the first computing task.

In some embodiments, because the configurable resource is determined by the idle resource of the at least one computing node, the virtual node necessarily learns of the idle resource of each computing node, the configurable resource may include a configurable sub-resource corresponding to the idle resource of each computing node, and whether the computing node satisfies the resource information is determined based on the configurable sub-resource corresponding to the idle resource of the computing node. If the computing node satisfies the resource information, the computing node may be determined as the target computing node. In some embodiments, if configurable sub-resources corresponding to a plurality of computing nodes in the at least one computing node all satisfy the resource information, there may be a plurality of target computing nodes.

In some embodiments, whether the computing node satisfies the resource information is determined based on the configurable sub-resource corresponding to the idle resource of the computing node, and the target computing node is determined in the computing node satisfying the resource information. In some embodiments, the target computing node is one of the computing nodes satisfying the resource information.

For example, for some embodiments, if there is only one computing node satisfying the resource information in the at least one computing node, the computing node is the target computing node.

For another example, if there are a plurality of computing nodes satisfying the resource information in the at least one computing node, one computing node may be randomly selected from the plurality of computing nodes satisfying the resource information as the target computing node. A ratio of a quantity of idle resources to a quantity of used resources of the computing node may be determined, a plurality of computing nodes satisfying the resource information are sorted based on the ratio, and a computing node having a largest ratio is selected as the target computing node. A computing node having a largest idle resource is selected from a plurality of computing nodes satisfying the resource information as the target computing node. If there is more than one computing node having the largest idle resource, one of the computing nodes having the largest idle resource may be randomly selected as the target computing node.

In an actual application, if a form of the resource includes a central processing unit demand amount and a memory demand amount, code formats of the idle resource are gocrane.io/cpu and gocrane.io/mem, and field formats in the resource information are cpu and mem. To execute the second computing task by using the target computing node, cpu and mem may be converted into gocrane.io/cpu and gocrane.io/mem.

Current resource information may include two types of demand amounts: the central processing unit demand amount and the memory demand amount. This is not limited. The code formats of the idle resource are not limited to gocrane.io/cpu or gocrane.io/mem, and the field formats in the resource information are not limited to cpu or mem.

203: Transmit the second computing task to the scheduling node, the second computing task being configured for indicating the scheduling node to execute the second computing task based on the target computing node.

In some embodiments, the second computing task may include the identifier of the target computing node, or may not include the identifier of the target computing node.

In some embodiments, there may be two cases that the second computing task includes the identifier of the target computing node.

Case 1: The target computing node is the computing node that ultimately executes the second computing task, and the scheduling node may schedule the second computing task to the target computing node based on the identifier of the target computing node.

Case 2: The target computing node is the computing node satisfying the resource information in the at least one computing node. If there is one target computing node, the target computing node is used as a computing node that ultimately executes the second computing task, and the scheduling node schedules the second computing task to the target computing node based on the identifier of the target computing node. If there is more than one target computing node, the scheduling node selects one of the target computing nodes as the computing node that ultimately executes the second computing task, and schedules the second computing task to a selected target computing node.

In some embodiments, when the second computing task does not include the identifier of the target computing node, for example, a field corresponding to a node identifier in the second computing task is null, the following two cases may be included.

Case 1: The scheduling node obtains the idle resource of the at least one computing node, and determines, based on the idle resource of each computing node, the computing node satisfying the resource information in the at least one computing node. The scheduling node determines the target computing node configured to execute the second computing task in the computing node satisfying the resource information, and schedules the second computing task to the target computing node.

Case 2: The scheduling node obtains the idle resource of the at least one computing node, and determines, based on the idle resource of each computing node, the target computing node satisfying the resource information in the at least one computing node. The scheduling node determines a computing node configured to execute the second computing task in the target computing node, and schedules the second computing task to the computing node.

Based on the foregoing two implementations, after the virtual node determines the computing node ultimately configured to execute the second computing task, an identifier of the computing node is annotated in the second computing task, to indicate the scheduling node to schedule the second computing task based on the identifier of the computing node in the second computing task. The scheduling may be determined by the scheduling node. A determining manner of the scheduling node may include that the second computing task includes identifiers of one or more computing nodes, and the scheduling node selects the identifiers of the one or more computing nodes; or the second computing task does not include the identifier of the computing node, and the scheduling node obtains the idle resource of the at least one computing node, and determines, based on the idle resource of the computing node, the computing node ultimately configured to execute the second computing task.

In some embodiments, when the target computing node is not unique, the second computing task may be configured for indicating the scheduling node to determine, based on the idle resource of the target computing node, the computing node that executes the second computing task in the target computing node.

For example, when receiving the second computing task, if the second computing task includes node information of the plurality of target computing nodes, the scheduling node determines the idle resource of the target computing node for each target computing node based on the node information of the target computing node, and determines, based on each target computing node, the computing node configured to execute the second computing task in the plurality of target computing nodes.

For another example, when the scheduling node receives the second computing task, if the second computing task does not include node information of any target computing node, the scheduling node obtains the idle resource of the at least one computing node, determines at least one target computing node based on the idle resource of each computing node, and further determines the computing node configured to execute the second computing task in the at least one target computing node.

In some embodiments, when the target computing node is not unique, the second computing task may be configured for indicating the scheduling node to determine, based on the idle resource of the computing node, the computing node that executes the second computing task in the target computing node.

For example, when the scheduling node receives the second computing task, if the second computing task does not include node information of any target computing node, the scheduling node obtains the idle resource of at least one computing node, and directly determines, based on the idle resource of each computing node, the computing node configured to execute the second computing task.

The resource scheduling method provided in some embodiments may be applied to the virtual node. The configurable resource in the virtual node is determined based on the idle resources of the at least one computing node, so that the idle resources of the at least one computing node are aggregated, and a configurable resource of one virtual node can represent all idle computing power of the computing nodes. After it is determined that there is the configurable resource in the virtual node, the computing task, for example, the first computing task, can be received based on the configurable resource. After receiving the first computing task, because the first computing task includes the resource information configured for representing the computing resource quantity for executing the first computing task, the virtual node may determine, based on the configurable resource, whether there is the target computing node satisfying the resource information in the at least one computing node. If there is the target computing node satisfying the resource information, because a data format of the idle resource is different from a data format of the resource information in the first computing task, considering that if the idle resource in the computing node may be used, format conversion may be performed on the data format of the resource information. Format conversion is performed on the resource information in the first computing task based on the field format of the idle resource, to obtain the second computing task. In some embodiments, when it is determined that there is the target computing node satisfying the resource information in the at least one computing node, use a control node to perform format conversion on the resource information in the computing task, and the virtual node is used to implement format conversion, so that intrusive modification to native code of the control node is avoided. A generated second computing task is transmitted to the scheduling node, to indicate the scheduling node to execute the second computing task based on the target computing node, so that the idle resource is reused on the premise of non-intrusive modification to the native code, and a utilization rate of a cluster resource may be improved at low costs.

In some embodiments, the resource scheduling method is applied to the virtual node, and the virtual node may determine the computing node configured to execute the second computing task in the at least one computing node. The performing format conversion on the resource information in the first computing task based on a field format of the idle resource if it is determined, based on the configurable resource, that there is a target computing node satisfying the resource information in the at least one computing node includes: if the computing node satisfying the resource information in the at least one computing node is determined based on the configurable resource, determining the target computing node in the computing node satisfying the resource information; and performing format conversion on the resource information in the first computing task based on the field format of the idle resource, and generating node information in the first computing task based on the node information of the target computing node, to obtain the second computing task, the second computing task being configured for indicating the scheduling node to execute the second computing task based on the node information that is of the target computing node and that is included in the second computing task.

The target computing node in some embodiments is the computing node that ultimately executes the second computing task.

In some embodiments, node information of the computing node is configured for indicating to identify the computing node, and the node information includes the identifier of the computing node. The node information included in the second computing task is the node information of the target computing node.

In some embodiments, the second computing task includes the node information of the target computing node, and the target computing node is the computing node that executes the second computing task. If the second computing task includes node information of more than one target computing node and if the node information includes only the identifier of the target computing node, the idle resource of the target computing node is determined based on the identifier of each target computing node, and the computing node that ultimately executes the second computing task is determined based on the idle resource of each target computing node. If the node information includes the idle resource of the target computing node, the computing node that ultimately executes the second computing task may be determined based on the idle resource of each target computing node.

In some embodiments, resources of the computing node may be divided into an idle resource and a used configuration resource. The resources of the computing node include, but are not limited to, a memory, a central processing unit, and the like. A total resource of the computing node includes, but is not limited to, at least one of an online resource, an offline resource, and a reserved resource.

A node agent of the computing node represents the idle resource of the computing node in a field format of gocrane.io/cpu. Data corresponding to gocrane.io/cpu in the computing node obtained by a node agent of the virtual node is the idle resource of the computing node.

For example, the node agent (Crane Agent) of the virtual node may obtain the idle resource of the computing node through a resource obtaining interface of the node agent of the computing node. For example, the resource is the CPU. It is assumed that there are an online task 1 to an online task 3. Actual use resource amounts currently corresponding to the online task 1 to the online task 3 are one core, six cores, and three cores respectively. Based on obtained actually used resources and a total resource of 100 cores of the computing node, where the reserved resource is 10 cores, it is determined that a current idle resource of the computing node is 80 cores, and data corresponding to gocrane.io/cpu in the computing node is displayed as 80 cores.

In some embodiments, the virtual node may determine, based on the configurable resource and the computing node satisfying the resource information, the computing node (for example, the target computing node) that ultimately executes the second computing task, and the virtual node generates the node information in the first computing task based on node information of the target computing node, to obtain the second computing task including the node information of the target computing node, so that the scheduling node directly determines, based on the node information in the second computing task, the computing node that executes the second computing task, to reduce a computation amount of the scheduling node.

In some embodiments, the resource scheduling method is applied to the virtual node. Whether the computing node is the target computing node may be determined based on a configurable resource corresponding to a configuration resource of the computing node. That it is determined, based on the configurable resource, that there is the target computing node satisfying the resource information in the at least one computing node includes: determining, for each computing node, the computing node as the target computing node if the configurable resource corresponding to the idle resource of the computing node is greater than or equal to the computing resource quantity for executing the first computing task.

In some embodiments, in the configurable resource of the virtual node, the configurable resource corresponding to the idle resource of the computing node is referred to as the configurable sub-resource, and when a quantity of the configurable sub-resource of the computing node is not less than a quantity of the computing resource quantity for executing the first computing task, it is determined that the idle resource of the computing node satisfies the resource information, and the computing node is further determined as the target computing node.

For some embodiments, in the at least one computing node, any computing node satisfying the resource information is determined as the target computing node. There may be more than one target computing node, for example, a computing node ultimately configured to execute the second computing task is one of the target computing nodes. In this case,
the second computing task may be configured for indicating the scheduling node to determine, based on the idle resource of the target computing node, the computing node that executes the second computing task in the target computing node.

For example, when receiving the second computing task, if the second computing task includes node information of the plurality of target computing nodes, the scheduling node determines the idle resource of the target computing node for each target computing node based on the node information of the target computing node, and determines, based on each target computing node, the computing node configured to execute the second computing task in the plurality of target computing nodes.

For another example, when the scheduling node receives the second computing task, if the second computing task does not include node information of any target computing node, the scheduling node obtains the idle resource of the at least one computing node, determines at least one target computing node based on the idle resource of each computing node, and further determines the computing node configured to execute the second computing task in the at least one target computing node.

In a cluster scenario in which a plurality of clusters are deployed online and offline in a mixed manner, when a plurality of offline computing tasks may use an idle resource in an online cluster, the offline computing tasks may be sorted. The scheduling node schedules the offline computing tasks to the virtual node in sequence based on the sorting, so that when determining that there is a target computing node satisfying the offline computing task in the online cluster, the virtual node performs format conversion on resource information in the offline computing task.

When each offline computing task is configured, an object configuring the offline computing task may simultaneously configure, based on importance of the offline computing task, an execution parameter value corresponding to the offline computing task. The execution parameter value specifies an execution ranking of the offline computing task. An offline computing task with lower importance corresponds to a lower execution parameter value, and is executed later. Resources may be allocated to the offline computing tasks corresponding to the execution parameter values in descending order of execution parameter values. For example, the execution parameter value may be a priority value of the offline computing task.

In some embodiments, when a quantity of the configurable resources corresponding to the idle resource of the computing node is not less than the computing resource quantity for executing the first computing task, the computing node may be determined as the target computing node, so that when the computing node executes the computing task, a problem that a computing quantity of idle resources does not satisfy a computing resource quantity for executing the computing task is avoided, to ensure that the computing node can smoothly execute the computing task.

In some embodiments, the resource scheduling method is applied to the virtual node. To enable the scheduling node to normally schedule the computing task to the virtual node, the virtual node may normally report the configurable resource of the virtual node to the scheduling node. Because the configurable resource of the virtual node is derived from the idle resource of the computing node, the virtual node may convert a field format of the obtained idle resource of the computing node based on a field format of the configurable resource. The method provided in some embodiments further includes: obtaining the idle resource of the at least one computing node; and performing conversion processing on the field format of the idle resource based on the field format of the configurable resource, to obtain the configurable resource.

In an actual application, field formats of the resource information of the computing task transmitted from a client are cpu and mem, and resources in these field formats may be referred to as native resources. If the computing task may use the native resource in the computing node, the resource information in the computing task may not be modified. If the computing task may use the idle resource in the computing node, format conversion may be performed on the field format of the resource information in the computing task based on the field format of the idle resource. To prevent the control node from converting the field format of the resource information in the computing task, the virtual node may report the configurable resource of the virtual node based on a field format of the native resource when reporting the configurable resource. The configurable resource is a native resource of the virtual node. The field format of the resource information transmitted from the client may not be modified, and the configurable resource may also be matched with the resource information, to facilitate subsequent determining of the target computing node.

For example, if the form of the resource includes the central processing unit demand amount and the memory demand amount, the virtual node obtains the idle resources in the field formats of gocrane.io/cpu and gocrane.io/mem of the computing node, and performs format conversion on the idle resources, to obtain the configurable resources in the field formats of cpu and mem.

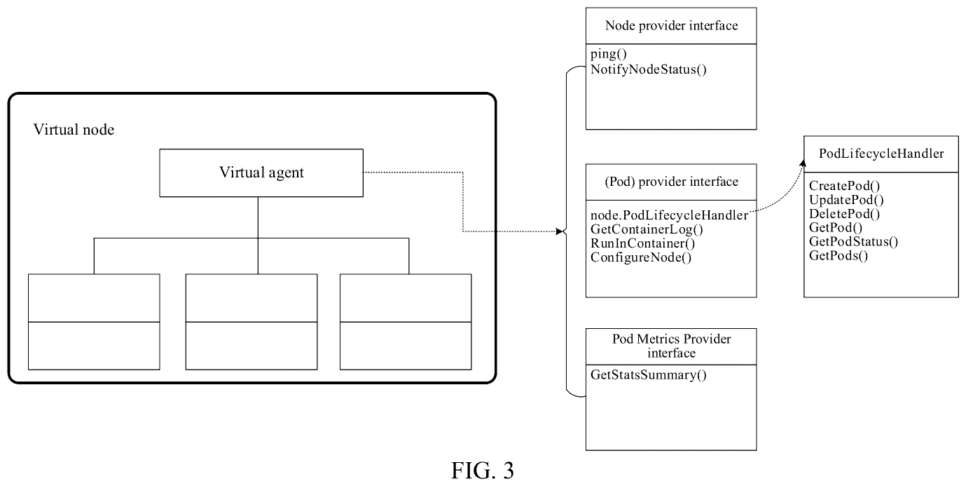

In some embodiments, FIG. 3 is a schematic diagram of a structure of a virtual node. The virtual node includes a node provider interface, a (Pod) provider interface, and a Pod metrics provider interface.

Responsibilities of a node provider include: (1) A Kubernetes node is to be created. (2) A health check and state reporting of the virtual node are to be completed. (3) Because the node is virtual, no computing node corresponds to a schedulable resource in the state of the virtual node. An idle resource of at least one computing node in a corresponding cluster may be obtained for the virtual node. The node provider obtains the at least one computing node in the cluster, aggregates an undeclared resource in the computing node and an unused resource with a Pod declaration into gocrane.io/cpu, to obtain an idle resource of the computing node, completes conversion of the idle resources into configurable resources, and reports the schedulable resource (for example, a configurable resource) of the virtual node to a scheduling node in a field format of cpu and mem. The scheduling node can learn that the virtual node has an available cpu resource, and an available mem resource (for example, the configurable resource). The node provider may include commands such as interface ping ( ) of a service state and NotifyNodeStatus ( ).

A (Pod) provider actually performs life cycle management of the Pod, and a virtual node Virtual Kubelet plays a role of an agent. Responsibilities of the (Pod) provider include: When the Pod is scheduled to the virtual node, a Pod list is read, and the Pod is scheduled to a corresponding computing node through the scheduling node; and when a scheduled Pod is deleted, virtual Kubelet may delete the Pod scheduled to the corresponding computing node through the scheduling node, to complete resource release. The (Pod) provider may include commands such as GetContainerLog ( ), RunInContainer ( ) describing whether a task is run in a container, and ConfigureNode ( ). The (Pod) provider further includes node.PodLifecycleHandler. Pod life cycle management includes commands such as CreatePod ( ), UpdatePod ( ), DeletePod ( ), GetPod ( ), GetPodStatus ( ), and GetPods ( ).

Main responsibilities of a Pod metrics provider include: The virtual node summarizes and reports states of all Pods to a management platform of the cluster. The Pod metrics provider may include a command such as GetStatsSummary ( ).

In some embodiments, the computing node may determine a configuration coefficient of the idle resource based on an allocated and used resource and a total resource in the computing node, and further determine the idle resource of the computing node based on the configuration coefficient of the idle resource. After the idle resource is determined, the idle resource is transmitted to the virtual node, so that the virtual node obtains the idle resource of the computing node.

In some embodiments, the configuration coefficient is configured to determine a parameter of the idle resource. A percentage of the used resource to the total resource may be used as a used proportion, a difference between 1 and the used proportion is used as a first candidate configuration coefficient of the idle resource, a preset configuration coefficient is used as a second candidate configuration coefficient, and a smaller one of the first candidate configuration coefficient and the second candidate configuration coefficient is selected as the configuration coefficient of the idle resource.

The preset configuration coefficient is a maximum proportion that may be allocated to the idle resource in the computing node. In an actual application, the preset configuration coefficient may be a configuration coefficient that is preset when the allocated and used resource in the computing node is 0. The preset configuration coefficient may not be greater than 50%. For example, the preset configuration coefficient may be 40%.

For example, a CPU is used as an example. Assuming that the computing node is configured with a total resource of 100 cores, and the allocated and used resource is 30 cores, it may be learned that the used proportion is 30%, and it may be learned that the first candidate configuration coefficient is 70%. If the preset configuration coefficient is 50%, it may be learned that the configuration coefficient of the idle resource is the preset configuration coefficient.

The total resource of the computing node may further include a buffering resource. If the used resource is not 0, the configuration coefficient of the idle resource is determined based on the allocated and used resource, an allocated and unused resource, a buffer, and an allocatable total resource; and if the used resource is 0, it is determined that the configuration coefficient of the idle resource is the preset configuration coefficient.

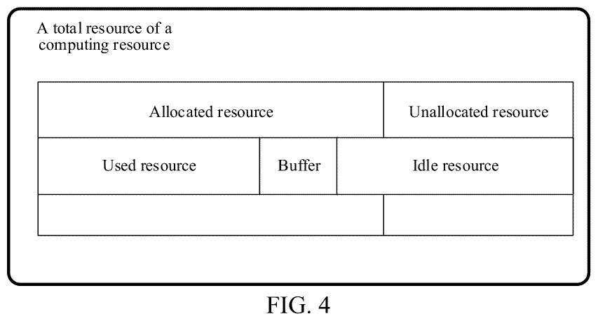

FIG. 4 is a schematic diagram of distribution of a total resource of a computing node according to some embodiments. The total resource of the computing node includes an allocated resource and an unallocated resource. The allocated resource further includes an allocated and used resource, an allocated and unused resource, and a buffer. The unused resource and the unallocated resource in the allocated resource may be used as an idle resource, and the buffer may buffer a currently running normal task. If there is a sudden computing task and resource avoidance is not performed, the buffer may be used for processing, to ensure that all computing tasks in the computing node can be successfully executed. A current super-configuration resource is determined based on the used resource, the buffer, and the allocatable total resource, for example, determined based on a super-configurable resource.

When a normal task is run in the computing node, for example, the allocated and used resource is not 0, the configuration coefficient of the idle resource is determined based on the allocated and used resource, the buffer, and the total resource. If there are many allocated and used resources, the configuration coefficient of the idle resource is small. If there are few allocated and used resources, the configuration coefficient of the idle resource is large, and a maximum configuration coefficient does not exceed the preset configuration coefficient. If the allocated and used resource is 0, the configuration coefficient of the idle resource is determined as a preset super-configuration coefficient. A problem that a large quantity of computing tasks are instantaneously scheduled to a same computing node to trigger resource stress can be avoided through the preset super-configuration coefficient.

In some embodiments, conversion processing is performed on an obtained resource format of the idle resource in at least one computing stage based on a field format of a configurable resource, to obtain the configurable resource, to ensure that the virtual node can receive the computing task.

In some embodiments, to ensure that a scheduling node can normally schedule a computing task for the virtual node, the scheduling node may obtain the configurable resource of the virtual node. The configurable resource is reported to the scheduling node. The configurable resource is used by the scheduling node to schedule a first computing task to the virtual node.

In some embodiments, a quantity of virtual nodes may be determined based on a quantity of clusters in which the computing node is located and that may be obtained. The virtual node may be in one-to-one correspondence with the cluster, for example, one virtual node correspondingly obtains the idle resource of the computing node in one cluster. The virtual node may be in one-to-many correspondence with the cluster, for example, one virtual node correspondingly obtains the idle resource of the computing node in a plurality of clusters.

For example, a plurality of virtual nodes may be deployed in one cluster, and each virtual node correspondingly obtains an idle resource of a computing node in one cluster. The idle resource may be an idle resource of a computing node in the cluster in which the virtual node is located, or may be an idle resource of a computing node in another cluster having an access credential.

For another example, the virtual node may obtain an idle resource of a computing node in the cluster in which the virtual node is located, and may further obtain an idle resource of a computing node in another cluster having an access credential.

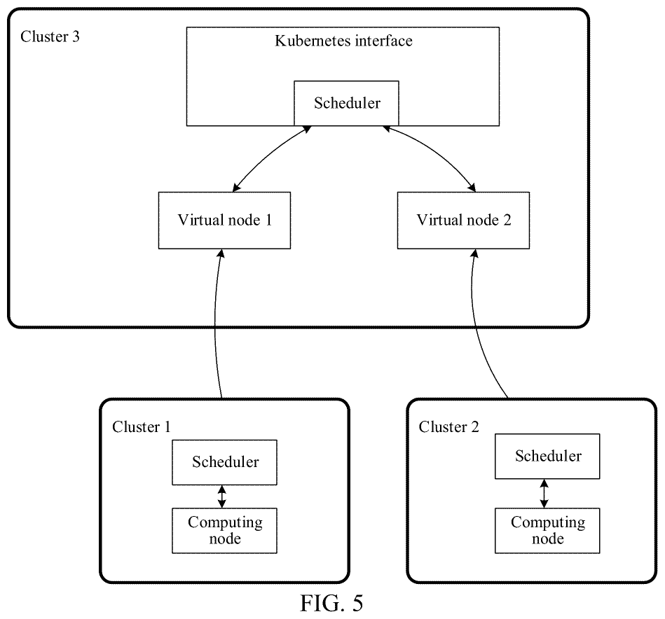

For example, with reference to FIG. 5, a cluster scenario in which a plurality of clusters are deployed online and offline in a mixed manner is used as an example. It is assumed that there are three clusters: a cluster 1, a cluster 2, and a cluster 3. The cluster 1 and the cluster 2 are online clusters, and the cluster 3 is an offline cluster. It is assumed that a virtual node is deployed in the cluster 3. If the virtual node is deployed based on a one-to-one correspondence between the virtual node and an online cluster that should be obtained, a virtual node 1 and a virtual node 2 are deployed in the cluster 3. The virtual node 1 has an access credential (for example, kubeconfig) of the cluster 1, and the virtual node 1 can obtain an idle resource of a computing node in the cluster 1 based on the access credential. The virtual node 2 has an access credential (for example, kubeconfig) of the cluster 2, and the virtual node 2 can obtain an idle resource of a computing node in the cluster 2 based on the access credential. The idle resource of the virtual node may be determined in the cluster 3, to facilitate subsequent task deployment based on the idle resource.

Based on the foregoing descriptions, after obtaining the idle resource of the computing node in the cluster 1, the virtual node 1 aggregates and performs format conversion on the idle resource of the computing node in the cluster 1, to obtain a configurable resource of the virtual node 1. The virtual node 1 reports the configurable resource to a scheduler (for example, the scheduling node) in the cluster 3. The scheduler in the cluster 3 schedules the first computing task (where the first computing task is the offline computing task) to the virtual node 1 based on the configurable resource of the virtual node 1. The virtual node 1 determines, based on the configurable resource, whether there is a computing node satisfying the resource information of the first computing task in the cluster 1. If there is the computing node satisfying the resource information, the target computing node is determined in the computing node satisfying the resource information of the first computing task. Format conversion is performed on the resource information based on the field format of the idle resource, and the node information of the first computing task is generated based on the node information of the target computing node, to obtain the second computing task.

With reference to the foregoing descriptions, after the second computing task is obtained, the virtual node 1 transmits the second computing task in the following two manners.

In a first manner, the virtual node 1 directly transmits the second computing task to a scheduler of the cluster 1, and the scheduler of the cluster 1 schedules, based on the node information in the second computing task, the second computing task to the computing node corresponding to the node information.

In a second manner, the virtual node 1 transmits the second computing task to the scheduler of the cluster 1 through the scheduler of the cluster 3, and the scheduler of the cluster 1 schedules, based on the node information in the second computing task, the second computing task to the computing node corresponding to the node information.

The online cluster and the offline cluster are both independent clusters and do not communicate with each other. Entrances of the clusters are completely isolated, and permissions of the clusters are also completely isolated. In some embodiments, the virtual node may be used as a bridge connecting the online cluster and the offline cluster, so that the offline cluster may use the virtual node to obtain the idle resource of the online cluster and deploy the task. The offline cluster may use the idle resource of the online cluster to execute the task without obtaining a permission of the online cluster. In some embodiments, a utilization rate of the idle resource of the online cluster can be improved at low costs without changing an original organization architecture and a permission isolation requirement.

In some embodiments, the virtual node reports the configurable resource of the virtual node to the scheduling node, so that the scheduling node schedules the computing task to the virtual node.

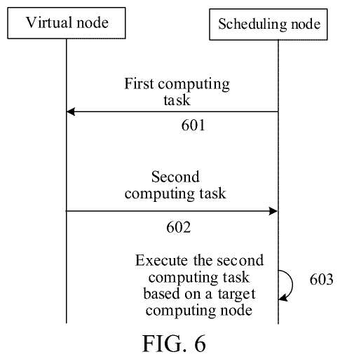

Refer to FIG. 6. Some embodiments further provide a resource scheduling method, applied to a scheduling node. The method includes the following operations.

601: Transmit a first computing task to a virtual node.

The first computing task includes resource information, the resource information is configured for representing a computing resource quantity for executing the first computing task, the first computing task is configured for indicating the virtual node to perform format conversion on the resource information in the first computing task based on a resource format of an idle resource when the virtual node determines, based on a configurable resource, that there is a target computing node satisfying the resource information in at least one computing node, to obtain a second computing task, and the configurable resource of the virtual node is determined based on an idle resource of the at least one computing node.

602: Receive the second computing task from the virtual node.

603: Execute the second computing task based on the target computing node.

Content of the operations in FIG. 6 is described. For additional implementation details, reference may be made to the descriptions of operations 201 to 203.

A resource scheduling method provided in some embodiments may be applied to a control node. After it is determined that there is a configurable resource in a virtual node, the control node transmits a computing task, for example, a first computing task, to the virtual node. Because the first computing task includes resource information configured for representing a computing resource quantity for executing the first computing task, the first computing task may be used to indicate the virtual node to determine, based on the configurable resource, whether there is a target computing node satisfying the resource information in at least one computing node. If there is the target computing node satisfying the resource information, because a data format of an idle resource is different from a data format of the resource information in the first computing task, considering that if the idle resource in the computing node may be used, format conversion may be performed on the data format of the resource information. The virtual node performs format conversion on the resource information in the first computing task based on a field format of the idle resource, to obtain a second computing task. In some embodiments, when it is determined that there is the target computing node satisfying the resource information in the at least one computing node, use the control node to perform format conversion on the resource information in the computing task, and the virtual node is used to implement format conversion, so that intrusive modification to native code of the control node is avoided. A scheduling node receives the second computing task from the virtual node, and executes the second computing task based on the target computing node, so that the idle resource is reused on the premise of non-intrusive modification to the native code, and a utilization rate of a cluster resource may be improved at low costs.

In some embodiments, the second computing task includes node information of the target computing node, and the executing the second computing task based on the target computing node includes: determining the target computing node based on the node information; and scheduling the second computing task to the target computing node.

In some embodiments, the target computing node is a computing node that ultimately executes the second computing task or a computing node satisfying the resource information. The node information of the target computing node includes an identifier of the target computing node, and the scheduling the second computing task to the target computing node includes: scheduling the second computing task to the target computing node based on the identifier of the target computing node when the target computing node is the computing node that ultimately executes the second computing task; scheduling the second computing task to the target computing node based on the identifier of the target computing node when the target computing node is the computing node satisfying the resource information and there is one target computing node; or selecting, when the target computing node is the computing node satisfying the resource information and there are a plurality of target computing nodes, the target computing node from the plurality of target computing nodes as the computing node that ultimately executes the second computing task, and scheduling the second computing task to a selected target computing node.

In some embodiments, the executing the second computing task based on the target computing node includes: determining, based on the idle resource of the target computing node, a computing node configured to execute the second computing task in the target computing node; and scheduling the second computing task to the computing node configured to execute the second computing task in the target computing node.

In some embodiments, the determining, based on the idle resource of the target computing node, a computing node configured to execute the second computing task in the target computing node includes: determining, when the second computing task includes node information of a plurality of target computing nodes, the idle resource of the target computing node based on the node information of the target computing node, and determining, based on each target computing node, the computing node configured to execute the second computing task in the plurality of target computing nodes; when the second computing task does not include node information of any target computing node, obtaining the idle resource of the at least one computing node, and determining, based on the idle resource of each computing node, the target computing node satisfying the resource information; determining the computing node configured to execute the second computing task in the target computing node; or when the second computing task does not include node information of any target computing node, obtaining the idle resource of the at least one computing node, determining, based on the idle resource of each computing node, the computing node satisfying the resource information, and determining, based on the computing node satisfying the resource information, the target computing node configured to execute the second computing task.

In some embodiments, the method further includes: receiving the configurable resource reported by the virtual node; and the transmitting the first computing task to the virtual node further includes: scheduling the first computing task to the virtual node if the configurable resource satisfies the resource information of the first computing task.

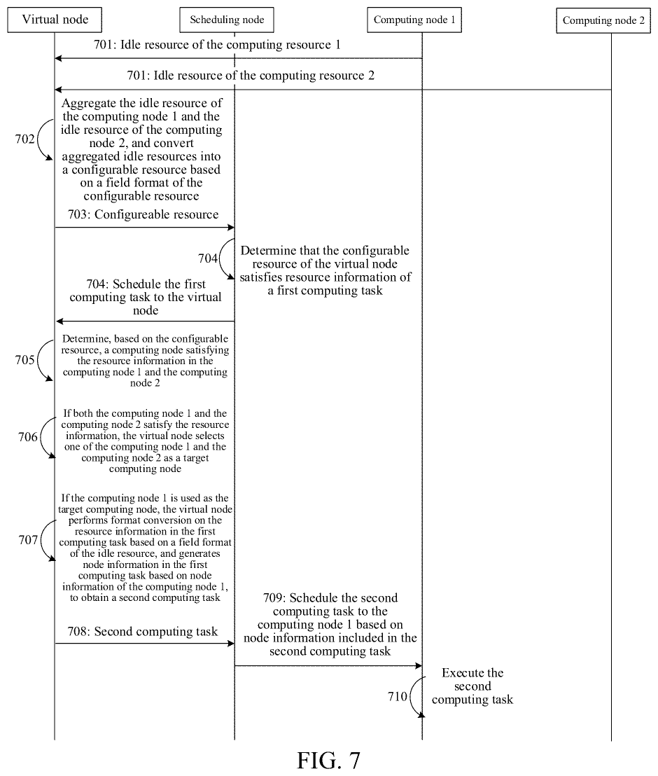

In some embodiments, if there are a plurality of first computing tasks, the transmitting the first computing task to the virtual node includes: sorting the first computing tasks based on a preset sorting manner, and scheduling the plurality of first computing tasks to the virtual node in sequence based on a sorting order. To better understand the resource scheduling method provided in some embodiments, with reference to FIG. 7, an exemplary description is provided by using a form of interaction between the virtual node, the control node, and the computing node. For example, the computing nodes are a computing node 1 and a computing node 2.

701: A virtual node receives an idle resource of the computing node 1 and an idle resource of the computing node 2.

702: The virtual node aggregates the idle resource of the computing node 1 and the idle resource of the computing node 2, and converts aggregated idle resources into a configurable resource based on a field format of the configurable resource.

703: The virtual node transmits the configurable resource to a scheduling node.

704: The scheduling node schedules a first computing task to the virtual node if determining that the configurable resource of the virtual node satisfies resource information of the first computing task.

The first computing task includes the resource information, and the resource information is configured for representing a computing resource quantity for executing the first computing task.

705: The virtual node determines, based on the configurable resource, a computing node satisfying the resource information in the computing node 1 and the computing node 2.

706: If both the computing node 1 and the computing node 2 satisfy the resource information, the virtual node selects one of the computing node 1 and the computing node 2 as a target computing node.

707: If the computing node 1 is used as the target computing node, the virtual node performs format conversion on the resource information in the first computing task based on a field format of the idle resource, and generates node information in the first computing task based on node information of the computing node 1, to obtain a second computing task.

708: The virtual node transmits the second computing task to the scheduling node.

709: The scheduling node schedules the second computing task to the computing node 1 based on node information included in the second computing task.

710: The computing node 1 executes the second computing task.

For operations 706 to 709, in some embodiments, if both the computing node 1 and the computing node 2 satisfy the resource information, the virtual node may use both the computing node 1 and the computing node 2 as target computing nodes. The virtual node performs format conversion on the resource information in the first computing task based on the field format of the idle resource, and generates the node information in the first computing task based on node information of the computing node 1 and the computing node 2, to obtain the second computing task. The scheduling node selects, based on the node information that is of the computing node 1 and the computing node 2 and that is included in the second computing task, one of the computing node 1 and the computing node 2 as the computing node that executes the second computing task.

For operations 706 to 709, in some embodiments, at least one of the computing node 1 and the computing node 2 satisfies the resource information. The virtual node performs format conversion on the resource information in the first computing task based on the field format of the idle resource, to obtain the second computing task. The scheduling node obtains idle resources of the computing node 1 and the computing node 2, and selects, based on the idle resources of the computing node 1 and the computing node 2 and the resource information in the second computing task, one of the computing node 1 and the computing node 2 as the computing node that executes the second computing task.

Although operations of the method in some embodiments are described in a specific order in the accompanying drawings, this does not require or imply that the operations need to be performed in such an order to achieve an expected result.

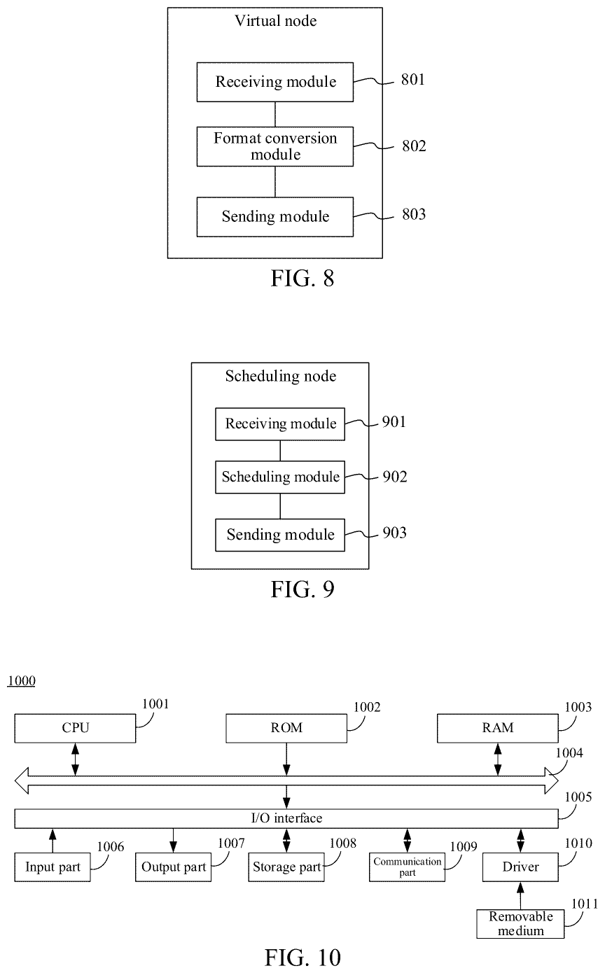

FIG. 8 is a schematic diagram of a block of a virtual node according to some embodiments.

As shown in FIG. 8, a configurable resource of a virtual node is determined by an idle resource of at least one computing node, and the virtual node includes a receiving module 801, a format conversion module 802, and a transmitting module 803.

The receiving module 801 is configured to receive a first computing task from a scheduling node, the first computing task including resource information, and the resource information being configured for representing a computing resource quantity for executing the first computing task.

The format conversion module 802 is configured to perform format conversion on the resource information in the first computing task based on a field format of the idle resource if it is determined, based on the configurable resource, that there is a target computing node satisfying the resource information in the at least one computing node, to obtain a second computing task.

The transmitting module 803 is configured to transmit the second computing task to the scheduling node, the second computing task being configured for indicating the scheduling node to execute the second computing task based on the target computing node.

In some embodiments, the format conversion module 802 may be configured to:
if the computing node satisfying the resource information in the at least one computing node is determined based on the configurable resource,
determine the target computing node in the computing node satisfying the resource information; and
perform format conversion on the resource information in the first computing task based on the field format of the idle resource, and generate node information in the first computing task based on node information of the target computing node, to obtain the second computing task, the second computing task being configured for indicating the scheduling node to execute the second computing task based on the node information that is of the target computing node and that is included in the second computing task.

In some embodiments, the format conversion module 802 may be configured to: determine, for each computing node, the computing node as the target computing node if a quantity of the configurable resources corresponding to the idle resource of the computing node is greater than or equal to the computing resource quantity for executing the first computing task.

In some embodiments, the second computing task may be configured for indicating the scheduling node to determine, based on the idle resource of the target computing node, the computing node that executes the second computing task in the target computing node.

In some embodiments, the receiving module 801 is further configured to obtain the idle resource of the at least one computing node.

The format conversion module 802 is configured to perform conversion processing on the field format of the idle resource based on the field format of the configurable resource, to obtain the configurable resource.

In some embodiments, the transmitting module 803 is further configured to report the configurable resource to the scheduling node, and the configurable resource is used by the scheduling node to schedule the first computing task to the virtual node.

According to the virtual node provided in some embodiments, the configurable resource in the virtual node is determined through the idle resources of the at least one computing node, so that the idle resources of the at least one computing node are aggregated, and the configurable resource of one virtual node can represent all idle computing power of the computing nodes. After it is determined that there is the configurable resource in the virtual node, the computing task, for example, the first computing task, can be received based on the configurable resource. After receiving the first computing task, because the first computing task includes the resource information configured for representing the computing resource quantity for executing the first computing task, the virtual node may determine, based on the configurable resource, whether there is the target computing node satisfying the resource information in the at least one computing node. If there is the target computing node satisfying the resource information, because a data format of the idle resource is different from a data format of the resource information in the first computing task, considering that if the idle resource in the computing node may be used, format conversion may be performed on the data format of the resource information. Format conversion is performed on the resource information in the first computing task based on the field format of the idle resource, to obtain the second computing task. In some embodiments, when it is determined that there is the target computing node satisfying the resource information in the at least one computing node, use the control node to perform format conversion on the resource information in the computing task, and the virtual node is used to implement format conversion, so that intrusive modification to native code of the control node is avoided. A generated second computing task is transmitted to the scheduling node, to indicate the scheduling node to execute the second computing task based on the target computing node, so that the idle resource is reused on the premise of non-intrusive modification to the native code, and a utilization rate of a cluster resource may be improved at low costs.

The units recorded in the virtual node correspond to the operations in the method described with reference to FIG. 2. Operations and features described above for the method are also applicable to a resource scheduling apparatus and units included in the resource scheduling apparatus. The virtual node may be implemented in a server in advance, or may be loaded to the server in a manner such as downloading. A corresponding unit in the virtual node may cooperate with a unit in a computer device to implement the solutions of some embodiments.

FIG. 9 is a schematic diagram of a block of a scheduling node according to some embodiments.

As shown in FIG. 9, the scheduling node includes a receiving module 901, a scheduling module 902, and a transmitting module 903.

The transmitting module 903 is configured to transmit a first computing task to a virtual node, the first computing task including resource information, the resource information being configured for representing a computing resource quantity for executing the first computing task, the first computing task being configured for indicating the virtual node to perform format conversion on the resource information in the first computing task based on a resource format of an idle resource when the virtual node determines, based on a configurable resource, that there is a target computing node satisfying the resource information in at least one computing node, to obtain a second computing task, and the configurable resource of the virtual node being determined based on an idle resource of the at least one computing node.

The receiving module 901 is configured to receive the second computing task from the virtual node.

The scheduling module 902 is configured to execute the second computing task based on the target computing node.

In some embodiments, the second computing task includes node information of the target computing node, and the scheduling module 902 may be configured to determine the target computing node based on the node information, and schedule the second computing task to the target computing node.

In some embodiments, the scheduling module 902 may be configured to:
determine, based on the idle resource of the target computing node, the computing node configured to execute the second computing task in the target computing node; and
schedule the second computing task to the computing node configured to execute the second computing task in the target computing node.

In some embodiments, the receiving module 901 is further configured to receive the configurable resource reported by the virtual node.

The transmitting module 903 may be configured to schedule the first computing task to the virtual node if the configurable resource satisfies the resource information of the first computing task.

According to some embodiments, each module may exist respectively or be combined into one or more modules. Some modules may be further split into multiple smaller function subunits, thereby implementing the same operations without affecting the technical effects of some embodiments. The modules are divided based on logical functions. In actual applications, a function of one module may be realized by multiple modules, or functions of multiple modules may be realized by one module. In some embodiments, the apparatus may further include other modules. In actual applications, these functions may also be realized cooperatively by the other modules, and may be realized cooperatively by multiple modules.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

Some embodiments provide a control node. After it is determined that there is the configurable resource in the virtual node, the control node transmits the computing task, for example, the first computing task, to the virtual node. Because the first computing task includes the resource information configured for representing the computing resource quantity for executing the first computing task, the first computing task may be used to indicate the virtual node to determine, based on the configurable resource, whether there is the target computing node satisfying the resource information in the at least one computing node. If there is the target computing node satisfying the resource information, because a data format of the idle resource is different from a data format of the resource information in the first computing task, considering that if the idle resource in the computing node may be used, format conversion may be performed on the data format of the resource information. The virtual node performs format conversion on the resource information in the first computing task based on a field format of the idle resource, to obtain the second computing task. In some embodiments, when it is determined that there is the target computing node satisfying the resource information in the at least one computing node, use the control node to perform format conversion on the resource information in the computing task, and the virtual node is used to implement format conversion, so that intrusive modification to native code of the control node is avoided. The scheduling node receives the second computing task from the virtual node, and executes the second computing task based on the target computing node, so that the idle resource is reused on the premise of non-intrusive modification to the native code, and a utilization rate of a cluster resource may be improved at low costs.

The units recorded in the scheduling node correspond to the operations in the method described with reference to FIG. 6. Operations and features described above for the method are also applicable to the scheduling node and units included in the scheduling node. The scheduling node may be implemented in a server in advance, or may be loaded to the server in a manner such as downloading. A corresponding unit in the scheduling node may cooperate with a unit in a computer device to implement the solutions of some embodiments.

For details undisclosed in the virtual node and the scheduling node in some embodiments, refer to details disclosed in some embodiments.

Referring to FIG. 10, FIG. 10 is a schematic diagram of a structure of a computer device for implementing some embodiments. As shown in FIG. 10, a computer system 1000 includes a central processing unit (CPU) 1001, and the central processing unit may perform various appropriate actions and processes based on a program stored in a read-only memory (ROM) 1002 or a program loaded to a random access memory (RAM) 1003 from a storage part 1008. Various programs and data for operation instructions of the system are stored in the RAM 1003. The CPU 1001, the ROM 1002, and the RAM 1003 are connected to each other through a bus 1004. An input/output (I/O) interface 1005 is connected to the bus 1004.

The following components are connected to the I/O interface 1005, including an input part 1006 of a keyboard, a mouse, and the like; including an input part 1007 of a cathode ray tube (CRT), a liquid crystal display (LCD), a speaker, and the like; including a storage part 1008 of hardware; and including a communication part 1009 of a network interface card such as a local area network (LAN) card, a modem, and the like. The communication part 1009 performs communication processing via a network such as the internet. A driver 1010 is also connected to the I/O interface 1005. A removable media 1011, such as a magnetic disk, an optical disk, a magneto-optical disk, a semiconductor memory, and the like are installed on the drive 1010, so that it may be read that a computer program is installed to the storage part 1008.

Based on some embodiments, the process described foregoing with reference to the flowchart FIG. 2 may be implemented as a computer software program. For example, some embodiments may include a computer program product, and the computer program product is carried on computer program of a computer-readable medium. The computer program includes a program code configured to perform the method shown in the flowchart. In some embodiments, the computer program includes a program code configured to execute the method shown in the flowchart. In some embodiments, the computer program may be uploaded and installed from the network by using the communication part 1009, and/or be installed from the removable media 1011. When the computer program is executed by the central processing unit (CPU) 1001, the foregoing functions of some embodiments are executed.

The computer-readable medium shown in some embodiments may be a computer-readable signal medium or a computer-readable storage medium, or any combination of the computer-readable signal medium and the computer-readable storage medium. The computer-readable storage medium may be, for example, but is not limited to, an electrical, magnetic, optical, electromagnetic, infrared, or a semiconductor system, apparatus or component, or any combination thereof. Examples of the computer-readable storage medium may include but are not limited to an electrical connection having one or more wires, a portable computer diskette, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any combination of thereof. In some embodiments, the computer-readable storage medium may be any tangible medium that includes or stores a program. The program may be used by an instruction execution system, apparatus, or device, or may be used by a combination of the instruction execution system, apparatus, or device. In some embodiments, the computer-readable signal medium may include a data signal propagated in a baseband or as a part of a carrier, and computer-readable program code is carried in the data signal. The propagated data signal may use various forms, including but not limited to an electromagnetic signal, an optical signal, or any appropriate combination of thereof. The computer-readable signal medium may further be any computer-readable medium other than the computer-readable storage medium. The computer-readable medium may transmit, propagate, or transmit a program used by the instruction execution system, apparatus, or device or used in combination with the instruction execution system, apparatus, or device. The program code included in the computer-readable medium may be transmitted by using any medium, including but not limited to a wireless medium, an electric line, an optical cable, an RF, or the like, or any combination thereof.

Flowcharts and block diagrams in the drawings illustrate architectures, functions, and operation instructions that may be implemented using the system, the method, and the computer program product according to some embodiments. Each block in the flowchart or the block diagram may represent a module, a program segment, or a part of code. The module, the program segment, or the part of the code include one or more executable instructions for implementing various logical functions. In some embodiments, the functions noted in the block may occur not in sequence noted in the drawings. For example, two blocks shown one after another may actually be executed substantially in parallel, or the two blocks may sometimes be executed in a reverse order. This depends on the functions involved. Each box in the block diagram and/or the flowchart and a combination of boxes in the block diagram and/or the flowchart may be implemented may using a dedicated hardware-based system configured to execute a function or operation instructions, or may be implemented by using a combination of dedicated hardware and computer instructions.

According to another aspect, some embodiments further provide a computer-readable storage medium. The computer-readable storage medium may be included in the computer device described in embodiments, and may also exist alone without being assembled into the computer device. The computer-readable storage medium stores one or more programs. The programs, when executed by one or more processors, perform the resource scheduling method described in some embodiments. For example, operations of the resource scheduling method shown in FIG. 2 may be performed or operations of the resource scheduling method shown in FIG. 6 may be performed.

Some embodiments provide a computer program product. The computer program product includes instructions, and when the instructions are run, the method described in some embodiments is performed. For example, operations of the resource scheduling method shown in FIG. 2 may be performed or operations of the resource scheduling method shown in FIG. 6 may be performed.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A resource scheduling method, applied to a virtual node, wherein a configurable resource of the virtual node is determined based on an idle resource of at least one computing node, the resource scheduling method comprising:
receiving, from a scheduling node, a first computing task comprising resource information indicating a computing resource quantity for executing the first computing task;
performing, based on the configurable resource indicating that there is a target computing node, from among the at least one computing node, that satisfies the resource information, format conversion on the resource information based on a field format of the idle resource to obtain a second computing task, wherein the second computing task comprises information about the target computing node for assigning the second computing task for execution; and
transmitting the second computing task to the scheduling node.

2. The resource scheduling method according to claim 1, wherein the performing the format conversion comprises:
determining the target computing node based on the configurable resource; and
performing format conversion on the resource information in the first computing task based on the field format of the idle resource, and generating first node information in the first computing task based on second node information of the target computing node, to obtain the second computing task, wherein the second computing task indicates the scheduling node to execute the second computing task based on the second node information.

3. The resource scheduling method according to claim 1, wherein the performing the format conversion comprises:
determining the target computing node, from among the at least one computing node, based on a quantity of first configurable resources corresponding to a first idle resource of a first computing node being greater than or equal to the computing resource quantity.

4. The resource scheduling method according to claim 1, wherein the second computing task instructs the scheduling node to determine, based on a first idle resource of the target computing node, a first computing node to execute the second computing task.

5. The resource scheduling method according to claim 1, further comprising:
obtaining the idle resource; and
obtaining the configurable resource by converting a first field format of the idle resource to a second field format.

6. The resource scheduling method according to claim 5, wherein the obtaining the idle resource comprises:
determining a configuration coefficient of the idle resource based on an allocated and used resource and a total resource of the at least one computing node; and
determining the idle resource based on the configuration coefficient.

7. The resource scheduling method according to claim 6, wherein the total resource comprises an allocated resource and an unallocated resource,
wherein the allocated resource comprises an allocated and used resource, an allocated and unused resource, and a buffer, and
wherein the idle resource comprises the allocated and unused resource and the unallocated resource.

8. The resource scheduling method according to claim 1, wherein the configurable resource is used by the scheduling node to schedule the first computing task to the virtual node, and
wherein the resource scheduling method further comprises reporting the configurable resource to the scheduling node.

9. The resource scheduling method according to claim 1, wherein a plurality of computing nodes satisfy the resource information, and
wherein the performing the format conversion comprises randomly selecting a first node, from among the plurality of computing nodes, as the target computing node.

10. The resource scheduling method according to claim 1, wherein a plurality of computing nodes satisfy the resource information, and
wherein the performing the format conversion comprises:
determining a plurality of ratios of quantities of idle resources to quantities of used resources corresponding to the plurality of computing nodes;
sorting the plurality of computing nodes based on the plurality of ratios; and
selecting a first computing node with a largest ratio, from among the plurality of computing nodes, as the target computing node.

11. A virtual node, wherein a configurable resource of the virtual node is determined by an idle resource of at least one computing node, the virtual node comprising:
at least one memory configured to store computer program code; and
at least one processor configured to read the program code and operate as instructed by the program code, the program code comprising:
receiving code configured to cause at least one of the at least one processor to receive, from a scheduling node, a first computing task comprising resource information indicating a computing resource quantity for executing the first computing task;
format conversion code configured to cause at least one of the at least one processor to perform, based on the configurable resource indicating that there is a target computing node, from among the at least one computing node, that satisfies the resource information, format conversion on the resource information based on a field format of the idle resource to obtain a second computing task, wherein the second computing task comprises information about the target computing node for assigning the second computing task for execution; and
transmitting code configured to cause at least one of the at least one processor to transmit the second computing task to the scheduling node.

12. The virtual node according to claim 11, wherein the format conversion code is configured to cause at least one of the at least one processor to:
determine the target computing node based on the configurable resource; and
perform format conversion on the resource information in the first computing task based on the field format of the idle resource, and generating first node information in the first computing task based on second node information of the target computing node, to obtain the second computing task, wherein the second computing task indicates the scheduling node to execute the second computing task based on the second node information.

13. The virtual node according to claim 11, wherein the format conversion code is configured to cause at least one of the at least one processor to:
determine the target computing node, from among the at least one computing node, based on a quantity of first configurable resources corresponding to a first idle resource of a first computing node being greater than or equal to the computing resource quantity.

14. The virtual node according to claim 1, wherein the second computing task is configured to instruct the scheduling node to determine, based on a first idle resource of the target computing node, a first computing node to execute the second computing task.

15. The virtual node according to claim 11, wherein the program code further comprises configurable resource code configured to cause at least one of the at least one processor to:
obtain the idle resource; and
obtain the configurable resource by converting a first field format of the idle resource to a second field format.

16. The virtual node according to claim 15, wherein the obtaining the idle resource comprises:
determine a configuration coefficient of the idle resource based on an allocated and used resource and a total resource of the at least one computing node; and
determine the idle resource based on the configuration coefficient.

17. The virtual node according to claim 16, wherein the total resource comprises an allocated resource and an unallocated resource,
wherein the allocated resource comprises an allocated and used resource, an allocated and unused resource, and a buffer, and
wherein the idle resource comprises the allocated and unused resource and the unallocated resource.

18. The virtual node according to claim 11, wherein the configurable resource is used by the scheduling node to schedule the first computing task to the virtual node, and
wherein the program code further comprises reporting code configured to cause at least one of the at least one processor to report the configurable resource to the scheduling node.

19. The virtual node according to claim 11, wherein a plurality of computing nodes satisfy the resource information, and
wherein the format conversion code is configured to cause at least one of the at least one processor to randomly select a first node, from among the plurality of computing nodes, as the target computing node.

20. A non-transitory computer-readable storage medium, storing computer code which, when executed by at least one processor, causes the at least one processor to at least:
receive a first computing task from a scheduling node, the first computing task comprising resource information, wherein the resource information indicates a computing resource quantity for executing the first computing task;
perform, based on a configurable resource of a virtual node indicating that there is a target computing node, from among at least one computing node, that satisfies the resource information, format conversion on the resource information based on a field format of an idle resource of the at least one computing node to obtain a second computing task, wherein the second computing task comprises information about the target computing node for assigning the second computing task for execution; and
transmit the second computing task to the scheduling node.
